(19) United States
(12) Patent Application Publication
(10) Pub. No.: US 2015/0363146 A1
(43) Pub. Date: Dec. 17, 2015

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventors: Takuya MIZUGUCHI, Kanagawa (JP); Toshio KAMADA, Kanagawa (JP); Toshiaki YOSHINARI, Kanagawa (JP); Kentaro IKEDA, Kanagawa (JP); Katsuyuki ASAI, Kanagawa (JP); Bo LIU, Kanagawa (JP); Kazuki NAGASHIMA, Kanagawa (JP)

(21) Appl. No.: 14/523,013

(22) Filed: Oct. 24, 2014

(30) Foreign Application Priority Data
Jun. 13, 2014 (JP) 2014-122055

(51) Int. Cl. G06F 3/12

(52) U.S. Cl. CPC G06F 3/1211; G06F 3/1259

(57) ABSTRACT

An information processing apparatus includes an extracting unit that extracts features of printing operations of a user, and a measurement unit that measures a processing throughput of executing the printing operations of the user as a substitute for a printing operation as a predetermined standard if a feature of the printing operation serving as the standard matches the features extracted by the extracting unit.

### CROSS-REFERENCE TO RELATED APPLICATIONS

This application is based on and claims priority under 35 USC 119 from Japanese Patent Application No. 2014-122055 filed Jun. 13, 2014.

### BACKGROUND

### Technical Field

The present invention relates to an information processing apparatus, an information processing method, and a non-transitory computer readable medium.

### SUMMARY

According to an aspect of the invention, there is provided an information processing apparatus including an extracting unit that extracts features of printing operations of a user, and a measurement unit that measures a processing throughput of executing the printing operations of the user as a substitute for a printing operation serving as a predetermined standard if a feature of the printing operation serving as the standard matches the features extracted by the extracting unit.

### BRIEF DESCRIPTION OF THE DRAWINGS

Exemplary embodiments of the present invention will be described in detail based on the following figures, wherein:

FIG. 1 illustrates a module configuration of a first exemplary embodiment;

FIG. 2 illustrates a configuration of a system implementing the first exemplary embodiment;

FIG. 3 illustrates an example of a data structure of a standard job feature table;

FIG. 4 illustrate an example of a data structure of a user job feature table;

FIG. 5 illustrate an example of a data structure of a job match determination table;

FIG. 6 is a flowchart illustrating a process example of the first exemplary embodiment;

FIG. 7 is a continuation of the flowchart of FIG. 6;

FIG. 8 is a flowchart illustrating a process example of the first exemplary embodiment;

FIG. 9 is a flowchart illustrating a process example of the first exemplary embodiment;

FIG. 10 illustrates a module configuration of a second exemplary embodiment;

FIG. 11 is a flowchart illustrating a process of the second exemplary embodiment;

FIG. 12 is a flowchart illustrating a process of the second exemplary embodiment;

FIG. 13 is a flowchart illustrating a process of the second exemplary embodiment;

FIG. 14 illustrates a module configuration of a third exemplary embodiment;

FIG. 15 illustrates a process of the third exemplary embodiment; and

FIG. 16 is a block diagram illustrating a hardware configuration of a computer implementing the exemplary embodiment.

### DETAILED DESCRIPTION

An underlying technique of measuring a printing processing throughput is described first before describing exemplary embodiments. The following description is also intended to help understand the exemplary embodiments.

Processing throughput of executing a printing operation in an image processing apparatus is measured. This is intended to detect a cause in performance degradation. To this end, a printing operation serving as a standard is periodically performed to measure operation results under the same condition and to compare measured results in time sequence. If the printing operation serving as the standard is not used, measurement results vary because of a difference in the printing operation. The difference caused by the number of pages and the number of objects tends to increase. On the other hand, if the printing operation serving as the standard is periodically performed to measure the operation results, a printing operation of a user is not performed during the printing operation as the standard. As a result, this period becomes a downtime (a suspension time throughout which the user is unable to operate the image processing apparatus). The execution of the printing process as the standard results in billing with no service performed.

Exemplary embodiments of the present invention are described with reference to the drawings.

### First Exemplary Embodiment

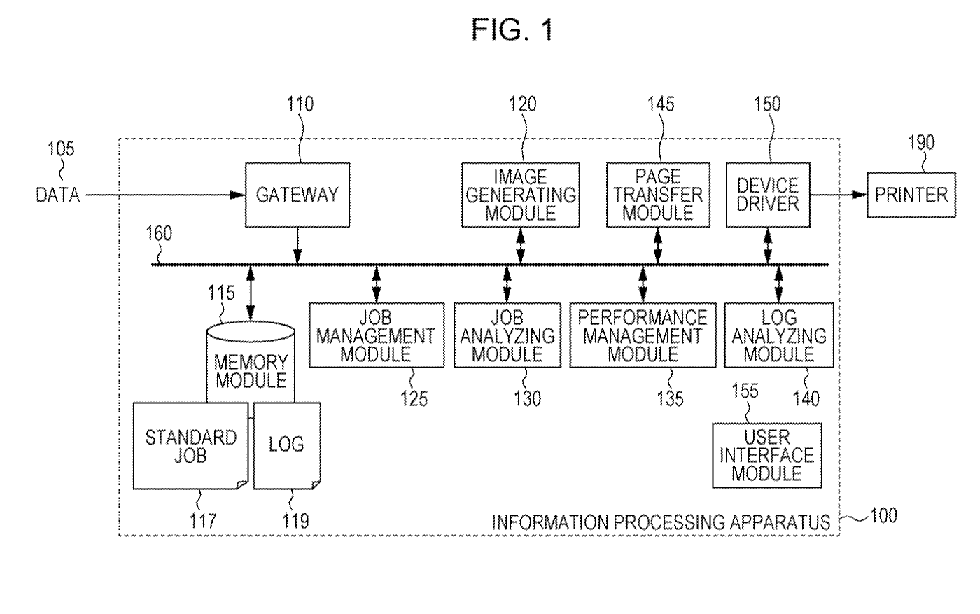

FIG. 1 illustrates a module configuration of a first exemplary embodiment.

The term “module” refers to a software component that is logically separable (a computer program), or a hardware component. The module of the exemplary embodiment refers to not only a module in a computer program but also a module in a hardware configuration. The discussion of the exemplary embodiment also serves as the discussion of computer programs for causing the modules to function (including a program that causes a computer to execute each step, a program that causes the computer to function as an element, and a program that causes the computer to implement each function), a system and a method. For convenience of explanation, the phrases “stores information,” “causes information to be stored,” and other phrases equivalent thereto are used. If the exemplary embodiment is a computer program, these phrases are intended to express “causes a memory device to store information” or “controls a memory device to cause the memory device to store information.” The modules may correspond to the functions in a one-to-one correspondence. In a software implementation, one module may form one program or multiple modules may form one program. One module may form multiple programs. Multiple modules may be executed by a single computer. A single module may be executed by multiple computers in a distributed environment or a parallel environment. One module may include another module. In the discussion that follows, the term “connection” refers to not only a physical connection but also a logical connection (such as an exchange of data, instructions, and data reference relationship). The term “predetermined” means that something is decided in advance of a process of interest. The term “predetermined” is thus intended to refer to something that is decided in advance of a process of interest in the exemplary embodiment. Even after a process in the exemplary embodiment has started, the term “predetermined” refers to something that is decided in advance of a process of interest depending on a condition or a status of the exemplary embodiment at the present point of time or depending on a condition or status heretofore continuing down to the present point of time. If “predetermined values” are plural, the predetermined values may be different from each other, or two or more of the predetermined values (including all the values) may be equal to each other. A statement that “if A, B is to be performed” is intended to mean that it is determined whether something is A, and that if something is determined as A, an action B is to be carried out. The statement becomes meaningless if the determination as to whether something is A is not performed.

The term “system” and the term “apparatus” refer to an arrangement where multiple computers, hardware configurations, and apparatuses are interconnected via a communication network (including a one-to-one communication connection). The term “system” and the term “apparatus” also refer to an arrangement that includes a single computer, a hardware configuration, and an apparatus. The term “system” and the term “apparatus” have the same definition and are interchangeable with each other. The system in the context of the exemplary embodiment does not include a social system that is a social arrangement formulated by humans.

At each process performed by a module, or at one of the processes performed by a module, information as a process target is read from a memory device, the information is then processed, and the process results are written onto the memory device. A description related to the reading of the information from the memory device prior to the process and the writing of the processed information onto the memory device subsequent to the process may be omitted as appropriate. The memory devices may include a hard disk, a random-access memory (RAM), an external storage medium, a memory device connected via a communication network, and a register within a central processing unit (CPU).

An information processing apparatus 100 as the first exemplary embodiment measures a processing throughput of a printing operation. As illustrated in FIG. 1, the information processing apparatus 100 includes a gateway 110, a memory module 115, an image generating module 120, a job management module 125, a job analyzing module 130, a performance management module 135, a log analyzing module 140, a page transfer module 145, a device driver 150, and a user interface module 155. The information processing apparatus 100 may be integrated with a printer 190 as a unitary apparatus.

A bus 160 interconnects the gateway 110, the memory module 115, the image generating module 120, the job management module 125, the job analyzing module 130, the performance management module 135, the log analyzing module 140, the page transfer module 145, and the device driver 150.

The printing operation (hereinafter also referred to as a job) is performed during a period from the moment the information processing apparatus receives a print instruction to the end of printing. The job includes storage of image data, reading of the image data, a generation process of print image data, and a printing operation to print the print image data onto a paper sheet. The job may further include a post-printing process (such as collating, paper folding, postcard crimping, or mail insertion).

The measurement of the processing throughput is performed to detect a cause in performance degradation. The performance degradation may include hard disk degradation, memory degradation, and interface port degradation. The risk of downtime caused by the performance degradation of the information processing apparatus is reduced by identifying and correcting the cause in the performance degradation. The information processing apparatus to be handled as a target is not limited to any particular type. The measurement of the processing throughput may be applied to a high-speed image processing apparatus, called a production printer.

The gateway 110 receives data 105 including a user's instruction for a printing operation.

In response to the data 105, the job management module 125 performs an operation of the information processing apparatus 100 for printing, and gives an instruction to the printer 190.

The memory module 115 stores a standard job 117, a log 119 and the like. The standard job 117 is predetermined, and set or updated by the performance management module 135. The log 119 is a log of each module in the information processing apparatus 100 or a log of the printer 190. More specifically, the log 119 is a record at the start time and end time of an operation.

The image generating module 120 generates print image data in response to the data 105 received by the gateway 110. More specifically, the image generating module 120 generates a bitmap image from the data 105 described in page description language (PDL).

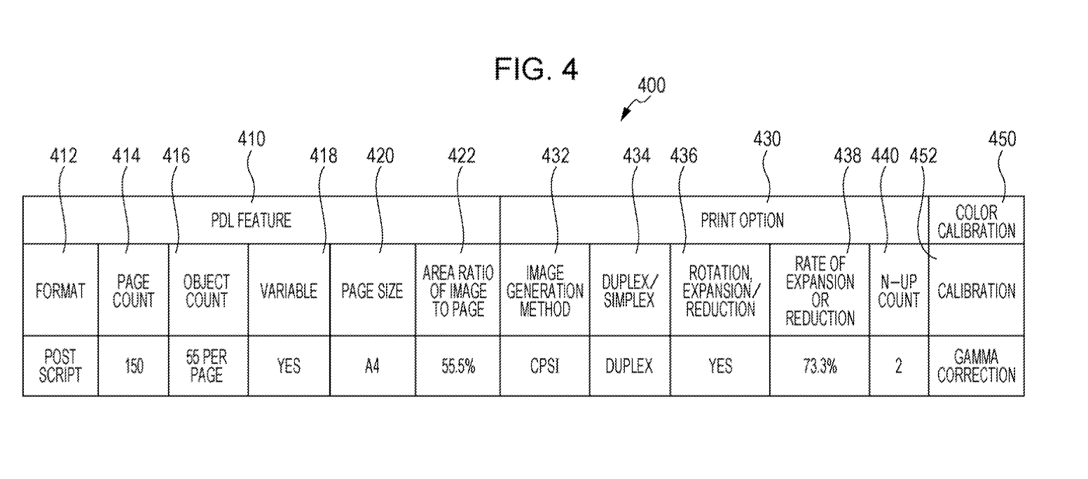

The job analyzing module 130 extracts a feature of a printing operation of a user from the data 105 received by the gateway 110. A specific example of the “feature of the printing operation of the user” is described below with reference to a user job feature table 400 of FIG. 4.

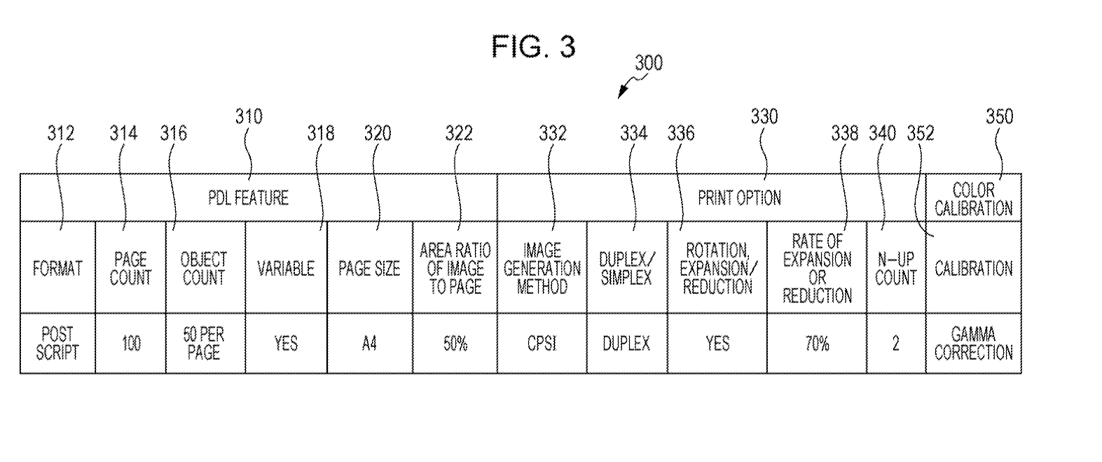

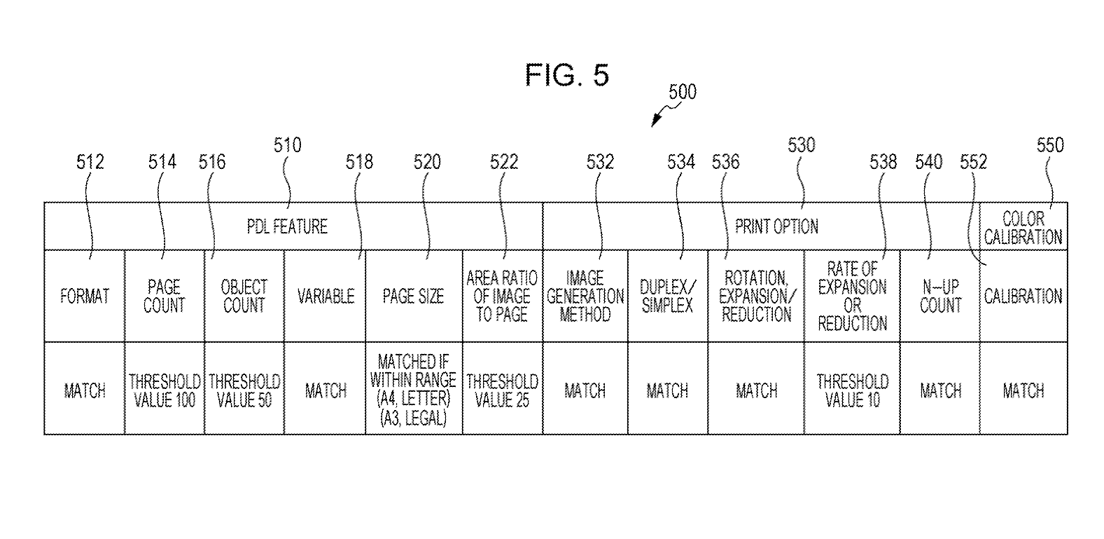

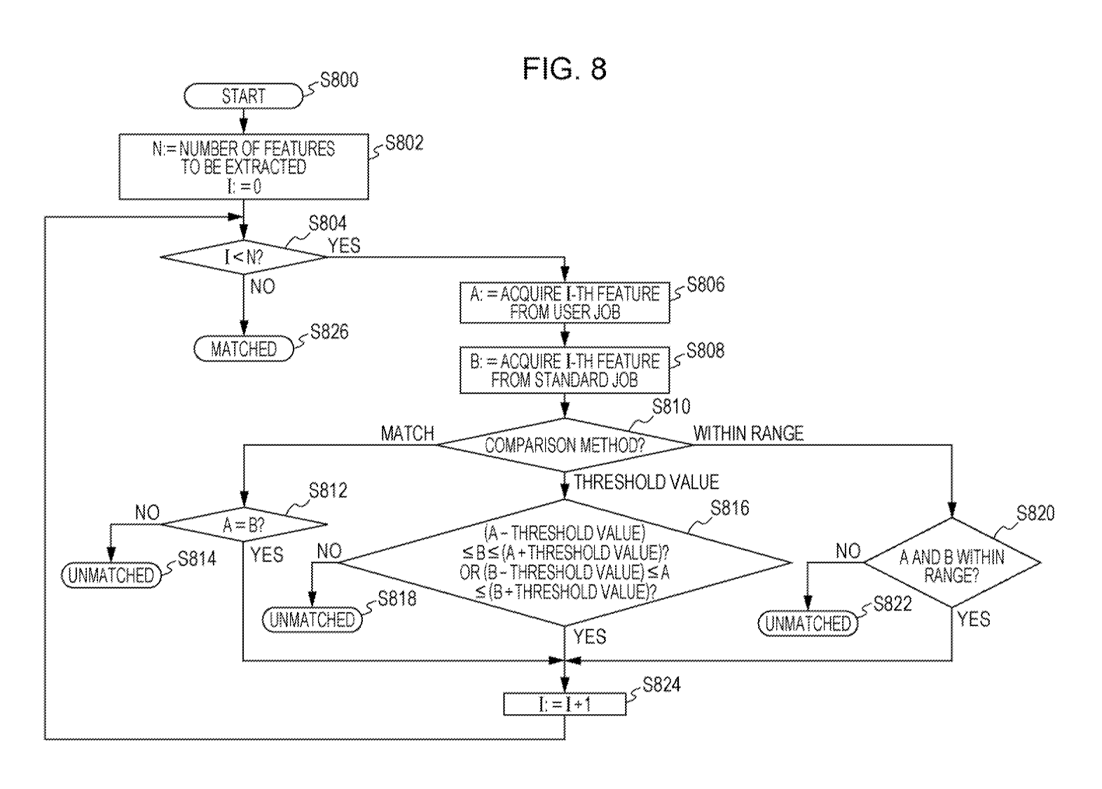

If the feature of a printing operation predetermined as a standard matches the feature extracted by the job analyzing module 130, the log analyzing module 140 measures a processing throughput in the execution of the printing operation of the user as a substitute for the standard printing operation. The “feature of the standard printing operation” is specifically described below with reference to a standard job feature table 300 of FIG. 3. The word “match” is intended to mean not only a mere match, but is also intended to mean that the jobs as comparison targets fall within a predetermined range. More specifically, the match is described with reference to a job match determination table 500 of FIG. 5 and a determination process illustrated in a flowchart of FIG. 8. The processing throughput may be measured at predetermined time intervals (timings).

The log analyzing module 140 compares with a predetermined threshold value a difference between a current measured processing throughput and processing throughput measured prior to the current measured processing throughput to give an alert. The alert may be given immediately. Alternatively, the comparison result may be simply registered as a trouble.

The log analyzing module 140 may measure the processing throughput as below. The log analyzing module 140 measures a process time in accordance with the log of each module in the information processing apparatus 100 or the log of the printer 190 (for example, records of process start time and process end time), and analyzes the printing operation of the user (an amount of process, and an attribute of a process target) (for example, analyses the process results of the job analyzing module 130) in order to measure the processing throughput. More specifically, an amount of process per unit time is measured by dividing the amount of process by the process time.

The performance management module 135 may configure a statistical value calculate from the printing operation of the user as the standard printing operation. The performance management module 135 sets or update the “standard printing operation”. The statistical values herein refer to a value, resulting from statistically processing the printing operations of multiple users, such as a mean value, a mode value, or a median.

More specifically, the feature of the printing operation does not necessarily match the feature of the standard printing operation. The feature of the printing operation of the user actually performed rather than the feature of the printing operation predetermined first as a standard is set to be the feature of the standard printing operation. More specifically, the log of the printing operation of the user is acquired, and the feature of the standard printing operation is determined using the log. For example, a printing operation having a feature most frequently specified in the printing operation of the user may be set to be the standard printing operation.

The user interface module 155 may display an alert generated by the log analyzing module 140 on a display device, such as a liquid-crystal display of the information processing apparatus 100, or may transmit an e-mail including the alert to the address of a person in charge.

The page transfer module 145 instructs the device driver 150 to transfer print image data to the printer 190.

The device driver 150 is connected to the printer 190. Under the control of the page transfer module 145, the device driver 150 transfers to the printer 190 the print image data generated by the image generating module 120.

The printer 190 is connected to the device driver 150. The printer 190 prints the print image data transferred from the device driver 150 onto a paper sheet. The printing method includes a related art technique, such an electrophotographic process or a ink-jet printing process.

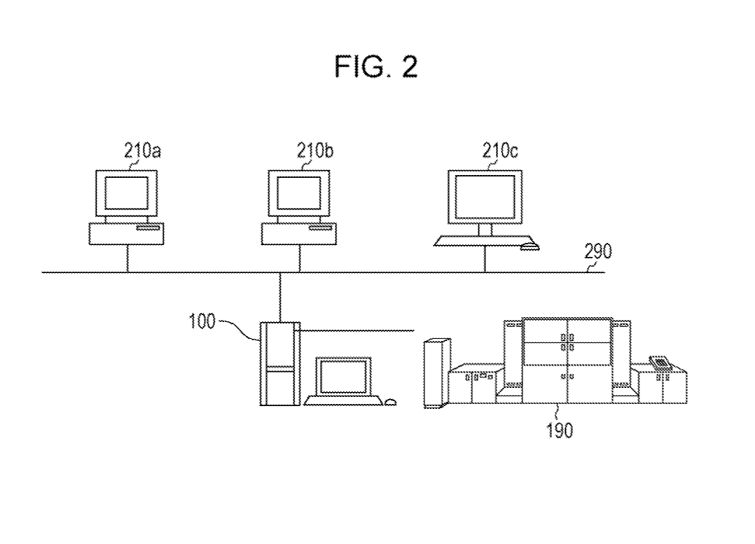

FIG. 2 illustrates a system configuration of the exemplary embodiment.

The information processing apparatus 100, a client terminal 210a, a client terminal 210b, and a client terminal 210c are mutually connected via a communication network 290. The communication network 290 may be a radio network, a wired network, or a combination thereof. The communication network 290 may also include an intranet or the Internet, as a communication infrastructure. The client terminal 210 generates the data 105, and in response to an operation of each user, transmits the data 105 to the information processing apparatus 100, and causes the printer 190 to print. The client terminal 210 is a personal computer (PC), for example. The configuration example of FIG. 2 is also applicable to a second exemplary embodiment and a third exemplary embodiment.

The process of each of the job analyzing module 130 and the log analyzing module 140 is described below.

FIG. 3 illustrates an example of a data structure of the standard job feature table 300. The standard job feature table 300 includes a PDL feature column 310, a print option column 330, and a color calibration column 350, and stores the features of the standard printing operation. The PDL feature column 310 stores the feature of an image forming target, the print option column 330 stores the feature of an operation method for image forming, the printing operation, and the color calibration column 350 stores the feature of the printing operation. These features serve as a standard according to which the printing throughput is measured. The PDL feature column 310 includes a format column 312, a page count column 314, an object count column 316, a variable column 318, a page size column 320, and an area ratio column 322 of a ratio of an image to a page. The print option column 330 includes an image generation method column 332, a duplex/simplex column 334, a rotation and expansion/reduction column 336, an expansion or reduction ratio column 338, and an N-UP count column 340. The color calibration column 350 includes a calibration column 352.

The PDL feature column 310 stores a PDL feature serving as a standard. The format column 312 stores a format serving as a standard as the PDL feature. The page count column 314 stores a page count serving as a standard. The object count column 316 stores an object count serving as a standard (indicates an amount of a print target, and specifically includes the number of drawings, the number of characters, and the number of images). The variable column 318 indicates that a performance measurement standard job is variable printing. The variable printing is intended to mean that “printing is performed on a page-by-page basis with print data content changing but with a print layout of text, line drawing, and image remaining unchanged”. Whether the printing operation becomes a standard job depends on whether the job is variable printing or not. If the variable printing is requested in the execution of a standard printing operation, a print target (specifically, an address, a name, a background and the like) is extracted from within the memory module 115. The page size column 320 stores a page size serving as a standard. The area ratio column 322 of an image on page stores an area ratio of an image to a page serving as a standard.

The page size column 330 stores a print option serving as a standard. The image generation method column 332 stores an image generation method serving as a standard as the print option. For example, postscript includes configurable postscript interpreter (CPSI), and Adobe PDF print engine (APPE). The duplex/simplex column 334 stores the type of duplex printing or simplex printing serving as a standard. The rotation and expansion/reduction column 336 stores the presence or absence of rotation, and expansion/reduction. The expansion or reduction ratio column 338 stores an expansion or reduction ratio serving as a standard. The N-UP count column 340 stores a “page count in the function of printing multiple pages on a single paper sheet” serving as a standard.

The color calibration column 350 stores color calibration serving as a standard. The calibration column 352 stores a calibration serving as a standard in the color calibration.

FIG. 4 illustrate an example of a data structure of the user job feature table 400. The user job feature table 400 indicates process results provided by the job analyzing module 130 and thus indicates analysis results of the data 105.

The user job feature table 400 includes a PDL feature column 410, a print option column 430, and a color calibration column 450, and has a data structure identical to that of the standard job feature table 300. The user job feature table 400 stores features of the printing operation of the user. More specifically, the user job feature table 400 lists the features of the printing operation the information processing apparatus 100 and the printer 190 are actually to perform. The PDL feature column 410 includes a format column 412, a page count column 414, an object count column 416, a variable column 418, a page size column 420, and an area ratio column 422 of an image on a page. The print option column 430 includes an image generation method column 432, a duplex/simplex column 434, a rotation and expansion/reduction column 436, an expansion or reduction ratio column 438, and an N-UP count column 440. The color calibration column 450 includes a calibration column 452.

The PDL feature column 410 stores a PDL feature of the printing operation of the user. The format column 412 stores a format of the data 105 as the PDL feature. The page count column 414 stores a page count of the data 105. The object count column 416 stores an object count of the data 105. The variable column 418 indicates whether the data 105 is variable or not. The page size column 420 stores a page size of the data 105. The area ratio column 422 stores an area ratio of an image to a page of the data 105.

The page size column 430 stores a print option of the printing operation of the user. The image generation method column 432 stores an image generation method of the data 105 as the print option. The duplex/simplex column 434 stores the type of duplex printing or simplex printing of the data 105. The rotation and expansion/reduction column 436 stores the presence or absence of rotation, and expansion/reduction of the data 105. The expansion or reduction ratio column 438 stores an expansion or reduction ratio of the data 105. The N-UP count column 440 stores a “page count in the function of printing multiple pages on a single paper sheet” of the data 105.

The color calibration column 450 stores color calibration of the printing operation of the user. The calibration column 452 stores a calibration of the data 105.

The standard job feature table 300 and the user job feature table 400 have been described for exemplary purposes only. Each of the standard job feature table 300 and the user job feature table 400 may include only some of the items thereof, or may further include other items, including the presence or absence of a font embedding or the number of fonts embedded.

FIG. 5 illustrates an example of a data structure of the job match determination table 500. The job match determination table 500 includes a PDL feature column 510, a print option column 530, and a color calibration column 550. The job match determination table 500 stores a determination method as to whether the feature of the standard printing operation matches the feature of the printing operation of the user. The log analyzing module 140 uses the determination method based on the job match determination table 500 to determine whether the standard job feature table 300 matches the user job feature table 400. The PDL feature column 510 includes a format column 512, a page count column 514, an object count column 516, a variable column 518, a page size column 520, and an area ratio column 522 of an image on a page. The print option column 530 includes an image generation method column 532, a duplex/simplex column 534, a rotation and expansion/reduction column 536, an expansion or reduction ratio column 538, and an N-UP count column 540. The color calibration column 550 includes a calibration column 552.

The PDL feature column 510 stores the determination method based on the PDL features. The format column 512 stores the determination method based on the format. The page count column 514 stores the determination method based on the page count. The object count column 516 stores the determination method based on the object count. The variable column 518 stores the determination method based on the variable printing. The page size column 520 stores the determination method based on the page size. The area ratio column 522 stores the determination method based on the area ratio of the image to the page.

The page size column 530 stores the determination method based on the print option. The image generation method column 532 stores the determination method based on the image generation method. The duplex/simplex column 534 stores the determination method based on the type of duplex printing or simplex printing. The rotation and expansion/reduction column 536 stores the determination method based on the presence or absence of rotation, and expansion/reduction. The expansion or reduction ratio column 538 stores the determination method based on the expansion or reduction ratio. The N-UP count column 540 stores the determination method based on a “page count in the function of printing multiple pages on a single paper sheet”.

The color calibration column 550 stores the determination method based on color calibration. The calibration column 552 stores the determination method based on the calibration. The determination method based on the calibration may be dependent on “match”. The match determination may be performed referring to whether to calibrate color. More specifically, if “any type of calibration is to be performed” on the two features, or if “no calibration is to be performed” on the two features, the two features are determined to be matched.

The term “match” in FIG. 5 indicates whether the two features are identical to each other. The term “threshold value N” in FIG. 5 has the following meaning. If a difference between the two features (the feature of the standard printing operation and the feature of the printing operation of the user corresponding thereto) is equal to or below the threshold value N, the two features are determined to be matched. The term “range” in FIG. 5 has the following meaning. If the two features fall within a range, the two features are determined to be matched. For example, “matched within range (A4, Letter), (A3, Legal)” is intended to mean that sheet size A4 and letter size match as the paper sheet size and that sheet size A3 and legal size match as the paper sheet size.

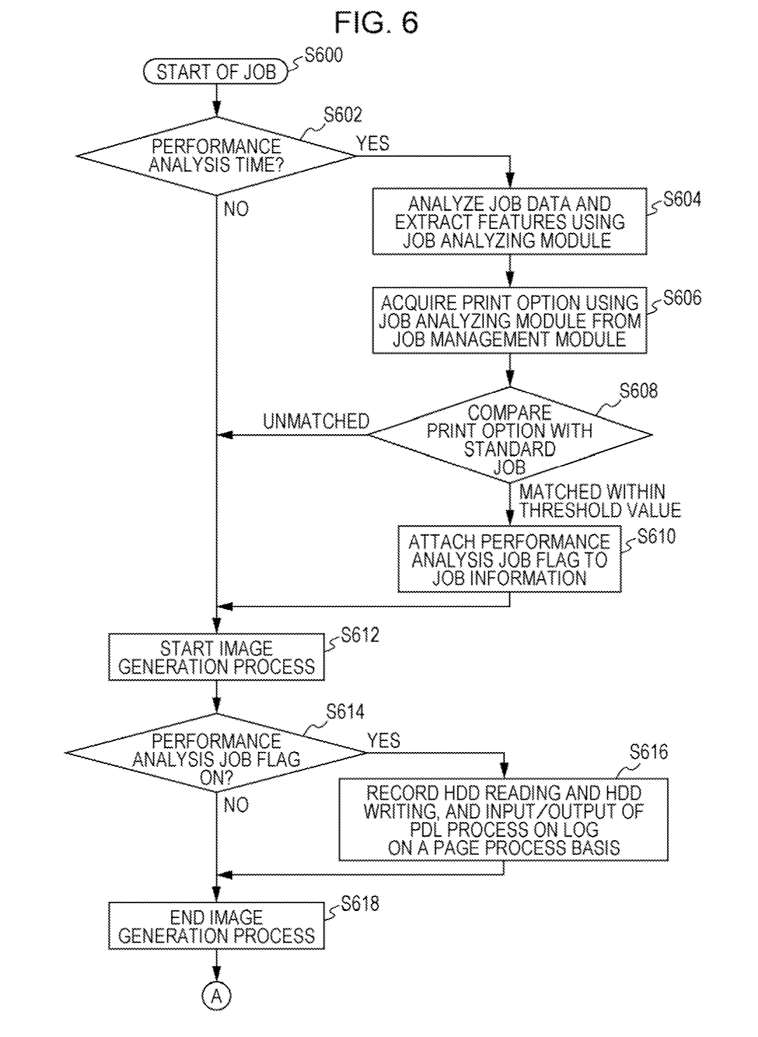

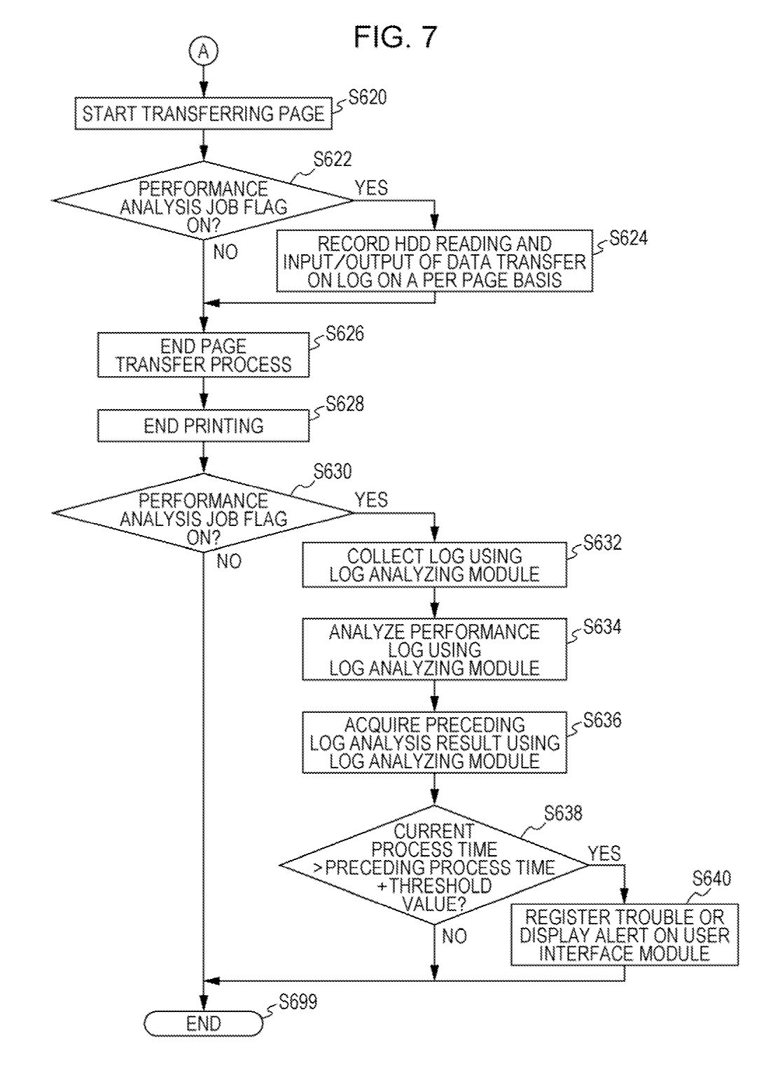

FIG. 6 and FIG. 7 are flowcharts illustrating an operation of the first exemplary embodiment.

In step S602, it is determined whether it is performance analysis time (processing throughput measurement time). If it is determined that it is performance analysis time (processing throughput measurement time), processing proceeds to step S604. Otherwise, processing proceeds to step S612. The performance analysis time may be set to be within a predetermined period of time. This is because the print instruction of the user may not necessarily occur periodically.

In step S604, the job analyzing module 130 analyzes job data in the data 105, and extracts a feature from the job data. More specifically, the PDL feature column 410 of the user job feature table 400 of FIG. 4 is generated.

In step S606, the job analyzing module 130 acquires a print option from the job management module 125. More specifically, the print option column 430 of the user job feature table 400 of FIG. 4 is generated. Additionally, the feature corresponding to the color calibration column 450 of the user job feature table 400 is extracted.

In step S608, the printing operation is compared with the standard job. If the two features match, processing proceeds to step S610. Otherwise, processing proceeds to step S612. More specifically, the standard job feature table 300 is compared with the user job feature table 400. The comparison process is described below with reference to a flowchart of FIG. 8.

In step S610, a performance analysis job flag is attached to job information. Since the performance analysis job flag is attached to the job information, results of determination operations in step S614, step S622, and step S630 are affirmative (yes).

In step S612, the image generating module 120 starts the image generation process.

In step S614, it is determined that the performance analysis job flag is on. If the performance analysis job flag is on, processing proceeds to step S616. Otherwise, processing proceeds to step S618.

In step S616, on a per page basis, hard disk reading, hard disk writing, and input/output of the PDL analysis process are recorded on log.

In step S618, the image generating module 120 ends the image generation process.

In step S620, the page transfer module 145 starts transferring a generated image to the printer 190.

In step S622, it is determined whether the performance analysis job flag is on. If the performance analysis job flag is on, processing proceeds to step S624. Otherwise, processing proceeds to step S626.

In step S624, hard disk reading and input/output of the data transfer are recorded onto the log on a per page basis.

In step S626, the page transfer module 145 ends the page transfer process.

In step S628, the printer 190 ends printing. The log of the printing operation may be collected herein.

In step S630, it is determined whether the performance analysis job flag is on. If the performance analysis job flag is on, processing proceeds to step S632. Otherwise, processing ends (step S699).

In step S632, the log analyzing module 140 collects the log. The log here is the one recorded in step S616, and step S624.

In step S634, the log analyzing module 140 analyzes a performance log.

In step S636, the log analyzing module 140 acquires the preceding log analysis results.

In step S638, it is determined whether the relationship of “(current process time)>(preceding process time+threshold value)” holds. If the relationship of “(current process time)>(preceding process time+threshold value)” holds, processing proceeds to step S640. Otherwise, processing ends (step S699).

In step S640, a trouble is registered or the user interface module 155 displays an alert. For example, an e-mail of alert may be transmitted to a person in charge.

FIG. 8 is a flowchart illustrating a process example of the first exemplary embodiment.

In step S802, a variable N and a variable I are set to be “N:=number of features to be extracted, and I:=0”.

In step S804, it is determined whether the relationship of I<N holds. If the relationship I<N holds, processing proceeds to step S806. Otherwise, processing proceeds to step S826.

In step S806, a variable A is set to be “A:=acquire I-th feature from user job”. More specifically, the value of each item in the user job feature table 400 is substituted for the variable A.

In step S808, a variable B is set to be “B:=acquire I-th feature from standard job”. More specifically, the value of each item in the standard job feature table 300 is substituted for the variable B.

In step S810, the comparison method is determined using the job match determination table 500. If the comparison method is based on the match, processing proceeds to step S812. If the comparison method is based on the threshold value, processing proceeds to step S816. If the comparison method is based on the range, processing proceeds to step S820.

In step S812, it is determined whether the relationship of A=B holds. If the relationship of A=B holds, processing proceeds to step S824. Otherwise, processing proceeds to step S814.

In step S814, it is determined that the features are unmatched.

In step S816, it is determined whether the relationship of “(A−threshold value)≦B≦(A+threshold value)” or “(B−threshold value)≦A≦(B+threshold value)” holds. If the relationship of “(A−threshold value)≦B≦(A+threshold value)” or “(B−threshold value)≦A≦(B+threshold value)” holds, processing proceeds to step S824. Otherwise, processing proceeds to step S818.

In step S818, it is determined that the two features are unmatched.

In step S820, it is determined whether A and B fall within a range. If the variables A and B fall within the range, processing proceeds to step S824. Otherwise, processing proceeds to step S822.

In step S822, it is determined that the two features are unmatched.

In step S824, the variable I is incremented by 1, and processing returns to step S804.

In step S826, it is determined that the two jobs are unmatched.

If there is at least one unmatched item in this process example, the determination result in step S608 is “unmatched”. Optionally, if the number of “unmatched items” is equal to or below a predetermined value, the determination result may be “matched”.

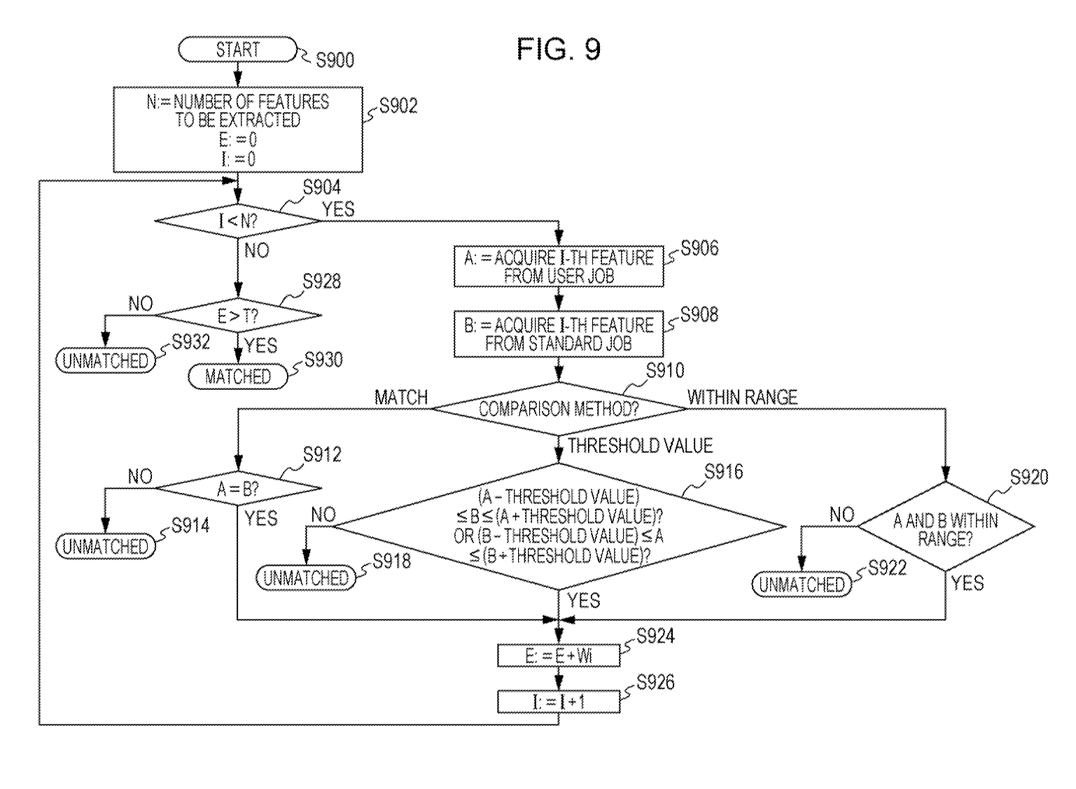

FIG. 9 is a flowchart illustrating a process example of the first exemplary embodiment. In FIG. 9, a weighting operation is added to the process of FIG. 8. More specifically, each item in the standard job feature table 300 and the user job feature table 400 is weighted. If the jobs match, a weight is added to that item. If a total value is equal to or above a predetermined threshold, the jobs are determined to be matched. In the weighting, features such as (1) the number of objects, (2) the variable printing, (3) the presence or absence of an embedded font, or (4) the number of embedded fonts may have a weight larger than in the other features.

Operations in steps S902 through S922 are respectively identical to operations in steps S802 through S822. Operations in step S924 thereafter are described below.

In step S924, “E:=E+Wi” is set. Wi represents a weight of an I(i)-th feature.

In step S926, the variable I is incremented by 1, and processing returns to step S904.

In step S928, it is determined whether the relationship of E>T holds. If the relationship of E>T holds, processing proceeds to step S930. Otherwise, processing proceeds to step S932. T represents a threshold value determined in the matched/unmatched determination in step S608.

In step S930, it is determined that the jobs are matched.

In step S932, it is determined that the jobs are unmatched.

### Second Exemplary Embodiment

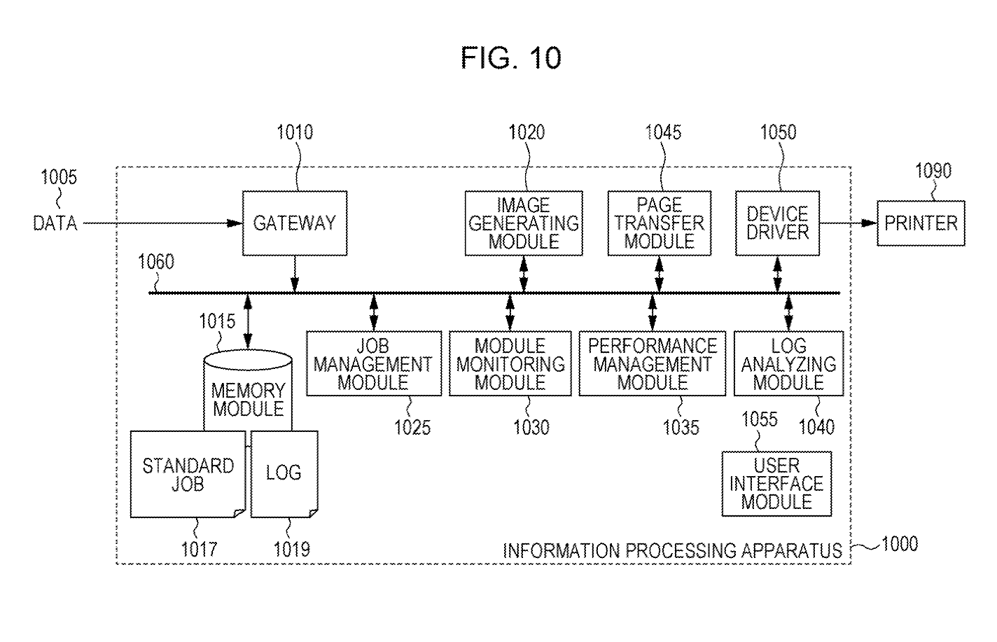

FIG. 10 illustrates a module configuration of an information processing apparatus 1000 of a second exemplary embodiment.

The information processing apparatus 1000 includes a gateway 1010, a memory module 1015, an image generating module 1020, a job management module 1025, a module monitoring module 1030, a performance management module 1035, a log analyzing module 1040, a page transfer module 1045, a device driver 1050, and a user interface module 1055. The gateway 1010, the memory module 1015, the image generating module 1020, the job management module 1025, the performance management module 1035, the page transfer module 1045, the device driver 1050, and a bus 1060 respectively function in a similar way to the gateway 110, the memory module 115, the image generating module 120, the job management module 125, the performance management module 135, the page transfer module 145, the device driver 150, and the bus 160 in the first exemplary embodiment of FIG. 1.

Each of the printing operations (including the printing operation of the user and the standard printing operation) includes a first operation and a second operation following the first operation. The first operation generates an image and is performed by the information processing apparatus 1000. The second operation prints the image and is performed by a printer 1090.

The first operation (image generation) is affected by the contents of the printing operation. The first operation of the standard printing operations is performed for measurement with the printing operation of the user not performed. The second operation (printing operation) subsequent to the image generation transfers the image data, and is thus not affected by the contents of the printing operation. The second operation of the printing operations of the user is performed for measurement. In this way, accurate measurement is performed in the standard printing operation while the printing operation of the user is performed without being interrupted. This arrangement enables the printing operation to be performed efficiently.

The module monitoring module 1030 monitors the printing operation of the user in the information processing apparatus 1000. The module monitoring module 1030 causes the first operation of the standard printing operations to be performed while the printing operation of the user is not performed.

The log analyzing module 1040 measures a first processing throughput in the execution of the first operation out of predetermined standard printing operations. More specifically, the log analyzing module 1040 measures the first processing throughput using the log of the first operation of the standard printing operations executed by the module monitoring module 1030. The log analyzing module 1040 extracts the feature of the second operation of the printing operations of the user. If the feature of the second operation of the standard printing operations matches the extracted feature of the second operation of the printing operations of the user, the log analyzing module 1040 measures the second processing throughput in the execution of the second operation of the printing operations of the user as a substitute for the second operation of the standard printing operations. The meaning of the term “match” remains unchanged from the first exemplary embodiment.

The log analyzing module 1040 gives an alert by comparing with a predetermined threshold a different between one of the first processing throughput and the second processing throughput and a previously measured corresponding one of the first processing throughput and the second processing throughput. The comparison operation herein may be performed between the first processing throughput of one side (the printing operation of the user) and the first processing throughput of the other side (the standard printing operation), and between the second processing throughput of the one side and the second processing throughput of the other side. Alternatively, the comparison operation may be performed between the sum of the first processing throughput and second processing throughput of the one side and the sum of the first processing throughput and second processing throughput of the other side.

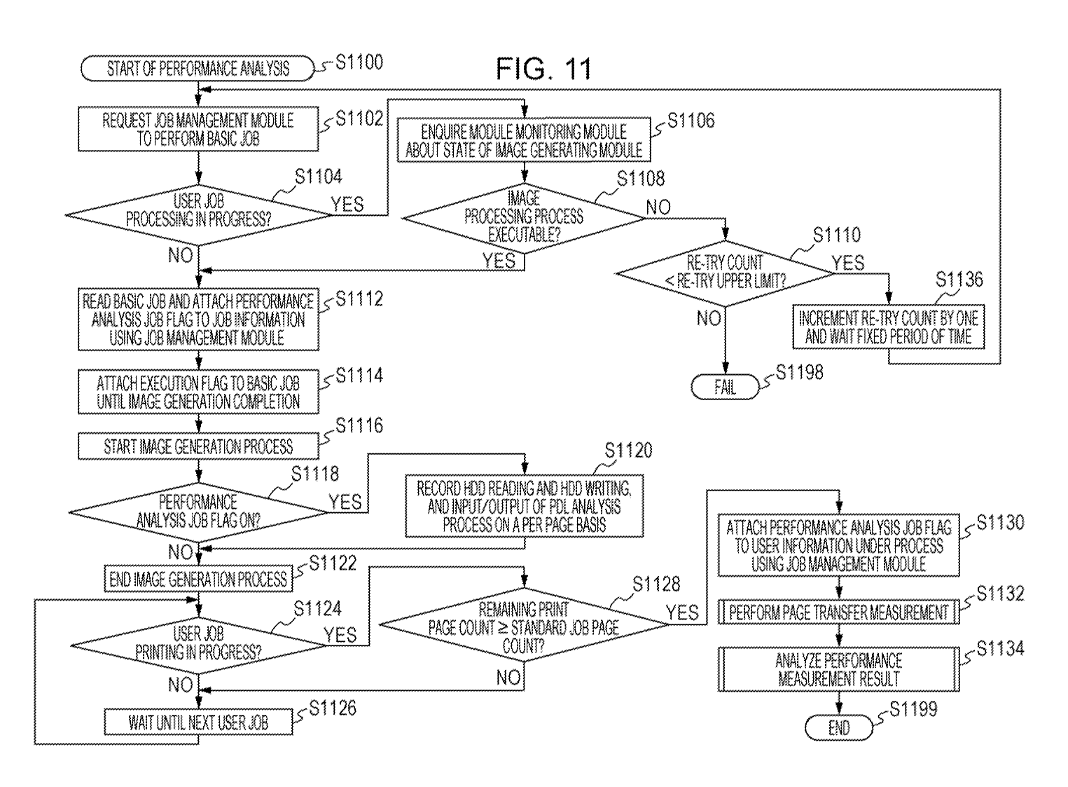

FIG. 11 is a flowchart illustrating a process of the second exemplary embodiment.

In step S1102, the performance management module 1035 requests the job management module 1025 to perform a basic job (the standard printing operation). More precisely, the performance management module 1035 requests the job management module 1025 to perform the first operation (image generation) of the basic job. If the determination result in step S602 in the flowchart of FIG. 6 is “yes”, the operation in step S1102 may be performed.

In step S1104, it is determined whether the user job (the printing operation of the user) is in progress. If the user job is in progress, processing proceeds to step S1106. Otherwise, processing proceeds to step S1112.

In step S1106, the module monitoring module 1030 is inquired of the state of the image generating module 1020.

In step S1108, it is determined whether an image generation process is executable in the image generating module 1020 (whether the first operation (image generation) of the basic job is executable in the image generating module 1020). If the image generation process is executable, processing proceeds to step S1112. Otherwise, processing proceeds to step S1110.

In step S1110, it is determined whether the relationship of a re-try count in the performance analysis process<re-try upper limit holds. If the relationship of the re-tray count>the re-try upper limit holds, processing proceeds to step S1136. Otherwise, processing proceeds to step S1198. The re-try count is a count at which a no-branch is followed in step S1108, and the re-try upper limit is a predetermined threshold value.

In step S1198, it is determined that the performance analysis has failed.

In step S1136, the re-try count is incremented by 1, and after a duration of time, processing returns to step S1102. The duration of time is a predetermined period of time.

In step S1112, the job management module 1025 reads the basic job, and attaches a performance analysis job flag to job information. The “performance analysis job flag” in step S1112 is a flag to the basic job (an image generation job), and is intended to mean that a print job is not to be performed in the basic job.

In step S1114, an execution flag is attached to the basic job until the end of the image generation.

In step S1116, the image generating module 1020 starts the image generation process.

In step S1118, it is determined whether the performance analysis job flag is on or not. If the performance analysis job flag is on, processing proceeds to step S1120. Otherwise, processing proceeds to step S1122.

In step S1120, on a per page basis, hard disk reading, hard disk writing, and input/output of the PDL analysis process are recorded on the log.

In step S1122, the image generating module 1020 ends the image generation process.

In step S1124, it is determined whether the user job printing is progress. If the user job printing is in progress, processing proceeds to step S1128. Otherwise, processing proceeds to step S1126.

In step S1126, processing waits on standby for a next user job.

In step S1128, it is determined whether the relationship of “a remaining print page count a standard job page count” holds. If the relationship of “the remaining print page count the standard job page count” holds, processing proceeds to step S1130. Otherwise, processing proceeds to step S1126. The remaining print page count is used as the feature of the second operation. Alternatively, another feature may be added to or used instead of the remaining print page count. In the determination operation in step S1128, a yes-branch may be followed if a difference between the remaining page count and the standard job page count is equal to or below a predetermined value.

In step S1130, the job management module 1025 attaches the performance analysis job flag to user information currently being processed. The “performance analysis job flag” in step S1130 is a flag for the user job (print job).

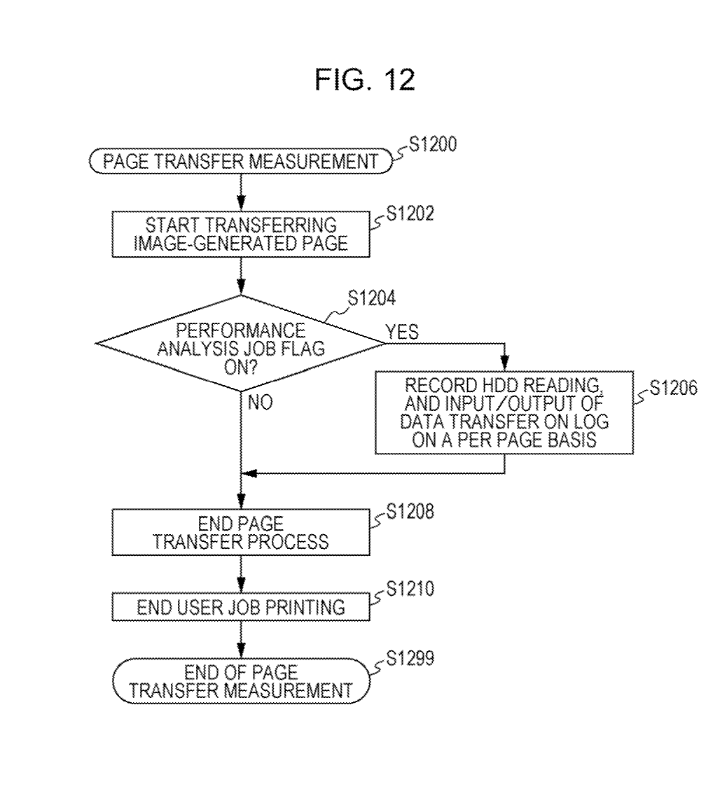

In step S1132, a page transfer is measured. The operation in step S1132 is described with reference to a flowchart of FIG. 12.

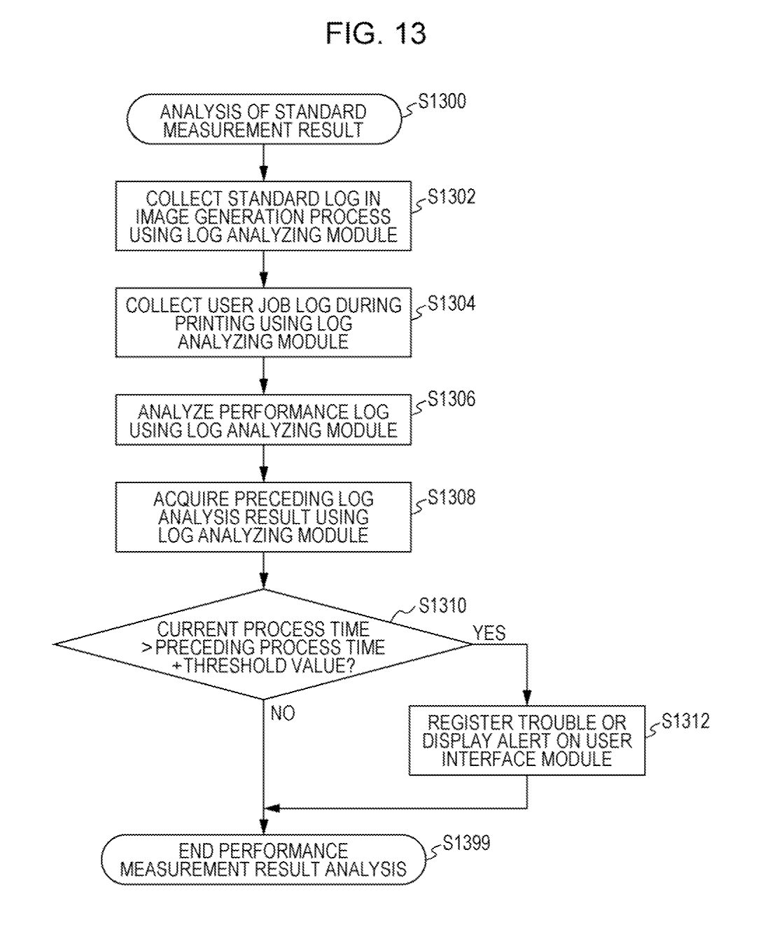

In step S1134, the performance measurement results are analyzed. The operation in step S1134 is described with reference to a flowchart of FIG. 13.

FIG. 12 is a flowchart illustrating a process (an example of the measurement process of the page transfer) of the second exemplary embodiment.

In step S1202, the page transfer module 1045 starts transferring a page with the generation of an image thereof completed.

In step S1204, it is determined whether the performance analysis job flag is on or not. If the performance analysis job flag is on, processing proceeds to step S1206. Otherwise, processing proceeds to step S1208.

In step S1206, on a per page basis, hard disk reading and input/output of the data transfer are recorded onto the log.

In step S1208, the page transfer module 1045 ends the page transfer process.

In step S1210, the user job printing is complete.

FIG. 13 is a flowchart illustrating an example of a process (an example of an analysis process of the measurement results) of the second exemplary embodiment.

In step S1302, the log analyzing module 1040 collects a standard job log in the image generation process. More specifically, the log analyzing module 1040 collects the log recorded in step S1120.

In step S1304, the log analyzing module 1040 collects the user job log during printing. More specifically, the log recorded in step S1206 is collected.

In step S1306, the log analyzing module 1040 analyzes a performance log.

In step S1308, the log analyzing module 1040 acquires preceding analysis results.

In step S1310, it is determined whether the relationship of “(current process time)>(preceding process time+threshold value)” holds. If the relationship of “(current process time)>(preceding process time+threshold value)” holds, processing proceeds to step S1312. Otherwise, processing ends (step S1399). The process time herein is the sum of image generation process time of the standard job and print process time of the user job printing. Alternatively, the process time may be related to each of the image generation process time and the print process time. More specifically, the current image generation process time may be compared with the preceding image generation process time, or the current print process time may be compared with the preceding print process time. Alternatively, the two comparison operations may be performed and if a yes-branch is followed in one of the two comparison results, a trouble-related operation in step S1312 may be performed.

In step S1312, a trouble is registered or the user interface module 1055 displays an alert.

### Third Exemplary Embodiment

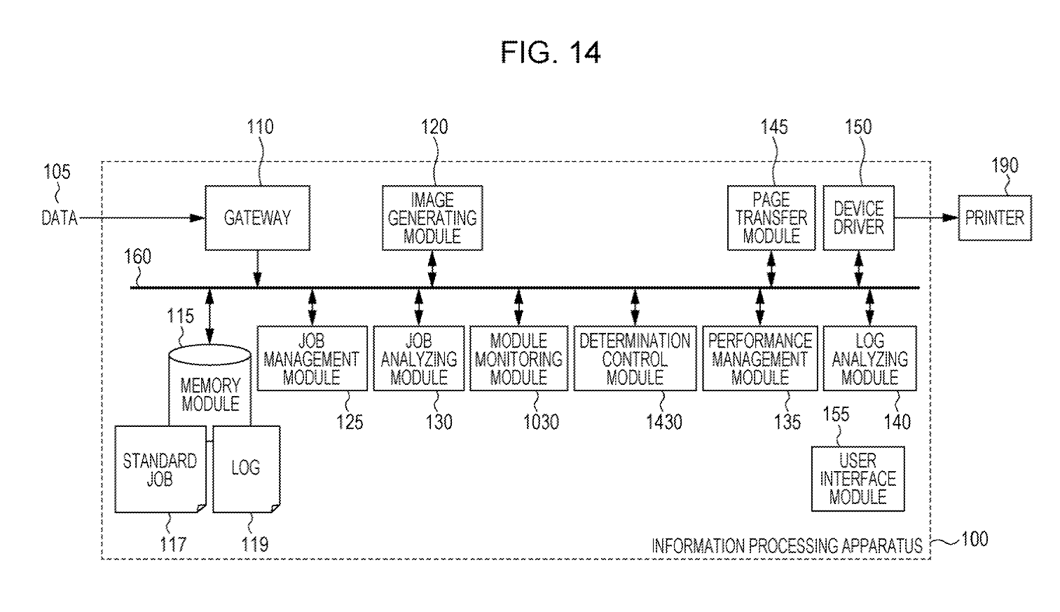

FIG. 14 illustrates a module configuration of an information processing apparatus 100 of a third exemplary embodiment.

The information processing apparatus 100 includes a gateway 110, a memory module 115, an image generating module 120, a job management module 125, a job analyzing module 130, a performance management module 135, a log analyzing module 140, a page transfer module 145, a device driver 150, a user interface module 155, a module monitoring module 1030, and a determination control module 1430. The third exemplary embodiment is a combination of the first and second exemplary embodiments. Elements identical to those in the first and second exemplary embodiments are designated with the same reference numerals and the discussion thereof is not repeated.

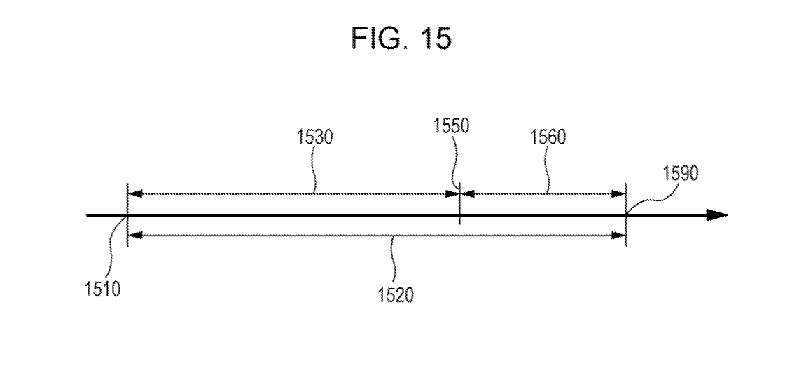

A duration of time throughout which the feature of the printing operation as the predetermined standard fails to match the feature extracted by the job analyzing module 130 may last for a predetermined period of time or longer. In such a case, the determination control module 1430 performs control so that the measurement operation is switched to the one described in the second exemplary embodiment and is performed. An example of FIG. 15 is described below. Start time 1510 indicates time at which the measurement operation of the processing throughput starts. For periodical measurement, the processing throughput is to be measured within a standard job measurement period 1520 lasting until end time 1590. If there is no printing operation of the user matching the feature of the standard printing operation, measurement is not performed at all as described in FIG. 6. The printing operation of the user does not necessarily occur within the standard job measurement period 1520. If the operation of the first exemplary embodiment is not complete by determination timing 1550, control is switched to the operation of the second exemplary embodiment. As illustrated in FIG. 15, a higher priority is placed on the operation of the first exemplary embodiment within a first exemplary embodiment period 1530 (from start time 1510 to the determination timing 1550). A higher priority is placed on the operation of the second exemplary embodiment if no printing operation of the user matching the feature of the standard printing operation occurs, namely, within a second exemplary embodiment period 1560 (from the determination timing 1550 to the end time 1590).

The determination control module 1430 may perform the measurement operation of the information processing apparatus 1000 of the second exemplary embodiment if a difference between the processing throughput measured by the information processing apparatus 100 of the first exemplary embodiment and the prior measured processing throughput is equal to or above a predetermined threshold value.

The measurement operation is performed even if the printing operation of the user fails to fully match the standard printing operation (if there is a difference between the printing operation of the user and the standard printing operation (the difference small enough to be practically determined to be matched)). For this reason, there is a possibility that an error is contained in the measurement result.

If the measurement result of the printing operation of the user is equal to or above the threshold value set from the previous measurement result, the measurement operation is performed in the standard printing operation of the second exemplary embodiment.

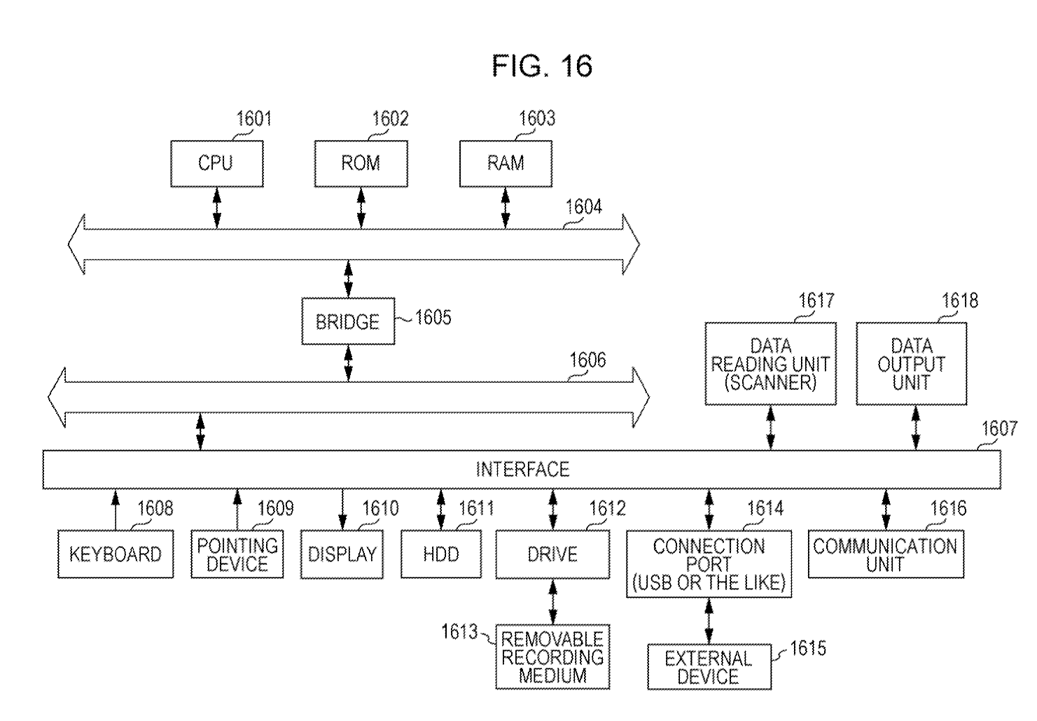

The hardware configuration of the information processing apparatus of the exemplary embodiment is described with reference to FIG. 16. FIG. 16 illustrates the hardware configuration as a personal computer (PC) including a data reading unit 1617, such as a scanner, and a data output unit 1618, such as a printer.

A central processing unit (CPU) 1601 is a controller that performs a process in accordance with a computer program. The computer program is a description of an execution sequence of each of the gateway 110, the image generating module 120, the job management module 125, the job analyzing module 130, the performance management module 135, the log analyzing module 140, the page transfer module 145, the device driver 150, the user interface module 155, the module monitoring module 1030, and the determination control module 1430.

A read-only memory (ROM) 1602 stores a program and an arithmetic parameter used by the CPU 1601. A random-access memory (RAM) 1603 stores the program to be executed by the CPU 1601 and a parameter that varies as appropriate in the execution of the program. These elements are mutually connected via a host bus 1604 including a CPU bus.

The host bus 1604 is connected to an external bus 1606, such as a peripheral component interconnect/interface (PCI) bus, via a bridge 1605.

A keyboard 1608, and a pointing device 1609, such as a mouse, are input devices configured to be operated by a user. A display 1610 includes a liquid-crystal display or a cathode ray tube (CRT), and displays a variety of information in the form of text or image.

A hard disk drive (HDD) 1611 includes and drives a hard disk, and records or reproduces the program to be executed by the CPU 1601 and information. The hard disk stores the standard job 1017, the log 1019, the print job of the user, and an image as a print target. The hard disk also stores a variety of data processing programs and a variety of computer programs.

A drive 1612 reads data or programs recorded on a removable recording medium 1613 mounted therewithin, such as a magnetic disk, an optical disk, a magnetic optical disk, or a semiconductor memory. The drive 1612 then transfers the data and the programs to the connected RAM 1603 via the interface 1607, the external bus 1606, the bridge 1605, and the host bus 1604. The removable recording medium 1613 is also usable as a data recording area in the same manner as the hard disk.

The connection port 1614 is configured to be connected to an external device 1615, and has a universal serial bus (USB) connection and a IEEE1394 connection. The connection port 1614 is connected to the CPU 1601 and the like via the interface 1607, the external bus 1606, the bridge 1605, and the host bus 1604. A communication unit 1616 is connected to a communication network, and performs a data communication process with the outside. The data reading unit 1617 is a scanner, for example, and reads a document. The data output unit 1618 is a printer, for example, and outputs document data.

The hardware configuration of the information processing apparatus of FIG. 16 is discussed for exemplary purposes only. The exemplary embodiment is not limited to this hardware configuration of FIG. 16 and may be acceptable in any form as long as the modules of the exemplary embodiment are implemented. For example, some modules may be implemented using an application specific integrated circuit (ASIC) or the like. In another example, some modules may be in an external system and connected to the system of FIG. 16 via a communication network. In yet another example, plural systems of FIG. 16 may be interconnected to each other via a communication line such that the systems operate in cooperation with each other. One of the modules may be incorporated in a copying machine, a facsimile device, a scanner, a printer, a multi-function apparatus (an image processing apparatus having at least two of the functions of the scanner, the printer, the copying machine, and the facsimile device).

In the above-discussion of comparison of predetermined values, terms “equal to or above”, “equal to or below”, “larger than”, and “smaller than (less than)” are respectively interpreted as being “larger than”, “smaller than (less than)”, “equal to or above”, and “equal to or below” as long as consistency is assured in the word usage.

The above-described program may be supplied in a stored state on a recording medium. The program may also be provided via communications. In such a case, the above-described program may be understood as an invention of a “non-transitory computer readable recording medium storing the program”.

The “non-transitory computer readable recording medium storing the program” refers to a computer readable recording medium storing the program, and is used to install the program, to execute the program, or to distribute the program.

The recording media include digital versatile disc (DVD), compact disc (CD), Blu-ray disc (registered trademark), magnetooptical disc (MO), flexible disc (FD), magnetic tape, hard disc, read-only memory (ROM), electronically erasable and programmable read-only memory (EEPROM (registered trademark)), flash memory, random-access memory (RAM), and secure digital (SD) memory card. The DVDs include “DVD-R, DVD-RW, and DVD-RAM” complying with the standard formulated by the DVD forum, and “DVD+R and DVD+RW” complying with DVD+RW standards. The CDs include read-only CD (CD-ROM), recordable CD-R, and rewritable CD-RW.

The program in whole or in part may be stored on the recording medium for storage and distribution. The program in whole or in part may be transmitted via a transfer medium. The transfer media include a wired network, a radio network, or a combination thereof. The wired and radio networks may include a local-area network (LAN), a metropolitan-area network (MAN), a wide-area network (WAN), the Internet, an intranet, and an extranet. The program in whole or in part may be transmitted over a carrier wave.

The program may be part of another program, or may be stored on the recording medium together with another program. The program may be split and split programs may then be separately stored on the recording media. The program may be processed in any fashion before being stored as long as the program remains restorable. For example, the program may be compressed or encrypted before storage.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an extracting unit that extracts features of printing operations of a user; and
a measurement unit that measures a processing throughput of executing the printing operations of the user as a substitute for a printing operation serving as a predetermined standard if a feature of the printing operation serving as the standard matches the features extracted by the extracting unit.

2. The information processing apparatus according to claim 1, further comprising an alert unit that gives an alert by comparing with a predetermined threshold value a difference between the measured processing throughput and a processing throughput previously measured.

3. An information processing apparatus comprising:
a first measurement unit that measures a first processing throughput of executing a first operation from among printing operations serving as a predetermined standard including the first operation to generate an image and a second operation to print the image;
an extracting unit that extracts a feature of a second operation of printing operations of the user; and
a second measurement unit that measures a second processing throughput of executing the second operation of the printing operations of the user as a substitute for the second operation of the printing operations serving as the standard if a feature of the second operation of the printing operations serving as the standard matches the feature extracted by the extracting unit.

4. The information processing apparatus according to claim 3, further comprising an alert unit that gives an alert by comparing with a predetermined threshold value a difference between one of the first processing throughput and the second processing throughput and a corresponding one of the first processing throughput previously measured and the second processing throughput previously measured.

5. The information processing apparatus according to claim 1, wherein the features of the printing operations serving as the predetermined standard include at least one of a feature of a target of image generation, a feature of an operation method of image generation, and a feature of a printing operation.

6. The information processing apparatus according to claim 2, wherein the features of the printing operations serving as the predetermined standard include at least one of a feature of a target of image generation, a feature of an operation method of image generation, and a feature of a printing operation.

7. The information processing apparatus according to claim 3, wherein the features of the printing operations serving as the predetermined standard include at least one of a feature of a target of image generation, a feature of an operation method of image generation, and a feature of a printing operation.

8. The information processing apparatus according to claim 4, wherein the features of the printing operations serving as the predetermined standard include at least one of a feature of a target of image generation, a feature of an operation method of image generation, and a feature of a printing operation.

9. The information processing apparatus according to claim 1, wherein a statistical value calculated from the printing operation of the user is used as a feature of the printing operation serving as the standard.

10. The information processing apparatus according to claim 2, wherein a statistical value calculated from the printing operation of the user is used as a feature of the printing operation serving as the standard.

11. The information processing apparatus according to claim 3, wherein a statistical value calculated from the printing operation of the user is used as a feature of the printing operation serving as the standard.

12. The information processing apparatus according to claim 4, wherein a statistical value calculated from the printing operation of the user is used as a feature of the printing operation serving as the standard.

13. The information processing apparatus according to claim 1, wherein if a duration throughout which the feature of the printing operation of the predetermined standard fails to match the feature extracted by the extracting unit lasts for predetermined period of time or longer,
the measurement unit measures the first processing throughput in the execution of the first operation to generate the image from among the printing operations of the predetermined standard,
the extracting unit extracts the feature of the second operation to print the image from among the printing operations of the user, and
the measurement unit measures the processing throughput of the second operation of the printing operations of the user as a substitute for the second operation of the printing operations as the standard if a feature of the second operation of the printing operations as the standard matches the feature extracted by the extracting unit.

14. The information processing apparatus according to claim 1, wherein if a difference between a current processing throughput and a processing throughput measured prior to the current processing throughput is equal to or above a threshold value,
the measurement unit measures the first processing throughput in the execution of the first operation to generate the image from among the printing operations as the standard,
the extracting unit extracts the feature of the second operation to print the image from among the printing operations of the user, and
the measurement unit measures the processing throughput of the second operation of the printing operations of the user as a substitute for the second operation of the printing operations as the standard if a feature of the second operation of the printing operations as the standard matches the feature extracted by the extracting unit.

15. An information processing method comprising:
extracting a feature of a printing operation of a user; and
measuring a processing throughput of executing the printing operation of the user as a substitute for a printing operation serving as a predetermined standard if a feature of the printing operation serving as the predetermined standard matches the feature extracted by the extracting unit.

16. An information processing method comprising:
measuring a first processing throughput of executing a first operation from among printing operations as a predetermined standard including the first operation to generate an image and a second operation to print the image;
extracting a feature of the second operation of printing operations of a user; and
measuring a second processing throughput of executing the second operation of the printing operations of the user as a substitute for the second operation serving as the standard if a feature of the second operation of the printing operations as the standard matches the feature extracted by the extracting unit.

17. A non-transitory computer readable medium storing a program causing a computer to execute a process for processing information, the process comprising:
extracting a feature of a printing operation of a user; and
measuring a processing throughput of executing the printing operation of the user as a substitute for a printing operation as a predetermined standard if a feature of the printing operation serving as the predetermined standard matches the feature extracted by the extracting unit.

18. A non-transitory computer readable medium storing a program causing a computer to execute a process for processing information, the process comprising:
measuring a first processing throughput of executing a first operation from among printing operations as a predetermined standard including the first operation to generate an image and a second operation to print the image;
extracting a feature of the second operation of printing operations of a user; and
measuring a second processing throughput of executing the second operation of the printing operations of the user as a substitute for the second operation of the printing operations as the standard if a feature of the second operation of the printing operations as the standard matches the feature extracted by the extracting unit.
